(19) United States
(12) Patent Application Publication
(10) Pub. No.: US 2009/0082907 A1
(43) Pub. Date: Mar. 26, 2009

(54) MECHANICALLY ISOLATED ENVIRONMENTAL TEST CHAMBER

(75) Inventors: Kevin David Stuvel, Longmont, CO (US); Andy Heyd, Longmont, CO (US); Jorge Alberto Hermosa, Boulder, CO (US)

Correspondence Address: McCarthy Law Group, 5830 Northwest Expressway, #353, Oklahoma City, OK, 73132, US

(73) Assignee: SEAGATE TECHNOLOGY LLC, Scotts Valley, CA (US)

(21) Appl. No.: 11/859,728

(22) Filed: Sep. 21, 2007

(51) Int. Cl. G05B 13/00

(52) U.S. Cl. 700/276

(57) ABSTRACT

In some embodiments a data storage device environmental test system and associated method of use is associated with a testing volume and a control volume that are separately contained in first and second enclosures, respectively, wherein the first and second enclosures possess no common structural member.

### BACKGROUND

Manufacturing operations have significantly evolved in complexity through the integration of highly sophisticated automation devices and methods. Gains have been realized both in productivity and reliability as past reliance on human judgment and manipulation has been replaced by processor-driven systems.

An example of this is manifested in the production equipment used in testing data storage devices, like the disc drive 10 depicted in FIG. 1. Such data storage devices 10 are routinely subjected to a prolonged “burn in” testing procedure during the manufacturing process, where predetermined temperature and humidity conditions are supplied so that reliable test results can be obtained. The data storage devices 10 are also subjected to thermal testing and thermal conditioning procedures during design and prototyping phases of manufacturing. These procedures typically subject the data storage devices 10 to relatively more harsh environmental extremes than those applied during production testing, usually being some multiple of the environmental conditions a data storage device 10 is likely to be exposed to during service.

During these tests the data storage devices 10 are densely packed inside a thermally controlled test chamber. During testing, the data storage devices 10 are very susceptible to mechanical excitations due to the precise positioning requirements necessary to maintain a data transfer relationship between a head 12 and media 14 in the data storage devices 10. Sources of mechanical excitation can come from motors, compressors, and fans in the environmental conditioning equipment that heats and cools the chamber. Previous attempted solutions were aimed at reducing the excitations below an acceptable level. Many of those attempted solutions are no longer valid due to increases in storage areal density in the media 14. This makes the data storage devices 10 more susceptible to data transfer errors because of positional errors created as a result of the mechanical excitations. It is to the effective elimination of those mechanical excitations that the claimed embodiments are directed.

### SUMMARY

Claimed embodiments are generally directed to an apparatus and associated method for functionally testing data storage devices.

In some embodiments a data storage device environmental test system and associated method of use are associated with a testing volume and a control volume that are separately contained in first and second enclosures, respectively, wherein the first and second enclosures possess no common structural member.

These and various other features and advantages which characterize the claimed embodiments will become apparent upon reading the following detailed description and upon reviewing the associated drawings.

### BRIEF DESCRIPTION OF THE DRAWINGS

FIG. 1 is an isometric depiction of a data storage device that is well suited for testing in accordance with embodiments of the present invention.

FIG. 2 is an isometric depiction of an environmentally controlled testing system constructed in accordance with embodiments of the present invention.

FIG. 3 is a diagrammatic elevational depiction of the testing system of FIG. 2.

FIG. 4 is an isometric depiction of a test cell of the testing system depicted in FIGS. 2 and 3.

FIG. 5 is an enlarged partial cross sectional view of the supply duct penetrating both enclosures.

FIG. 6 is a diagrammatic top view depicting a door in the rear wall affording access to the backplane in the testing system of FIGS. 2 and 3.

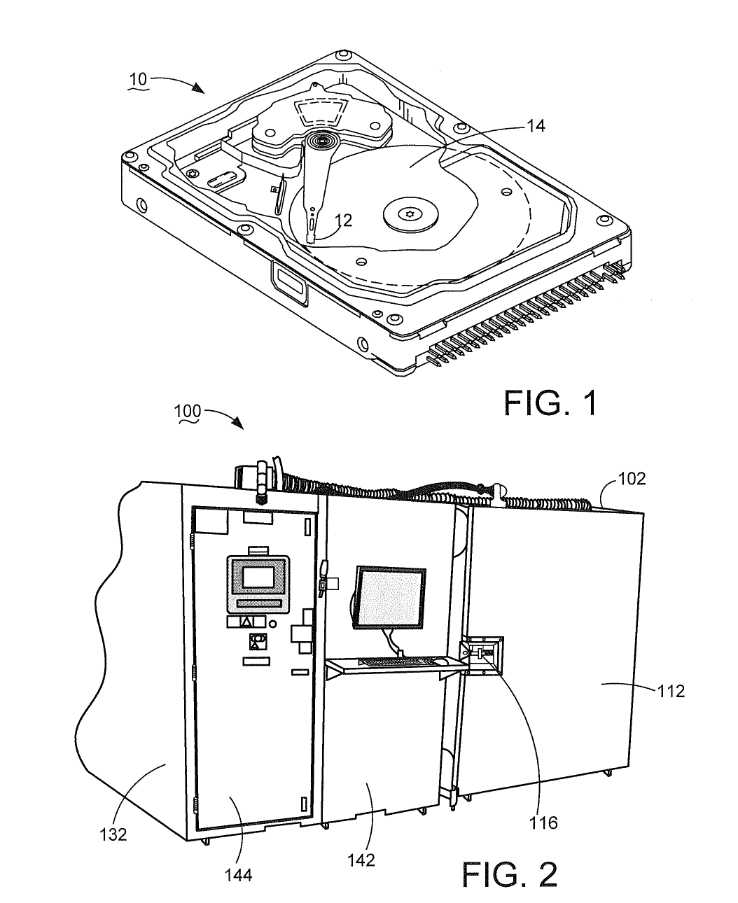

### DETAILED DESCRIPTION

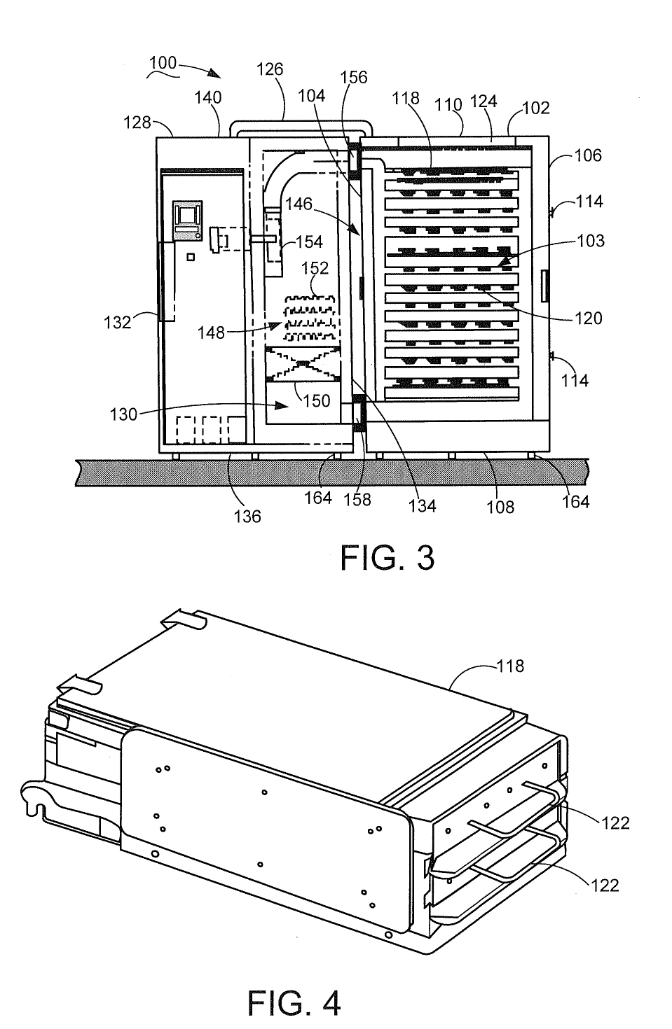

Turning to the FIGS. generally, and for now particularly to FIGS. 2 and 3. FIG. 2 depicts an isometric view and FIG. 3 is a diagrammatic elevational depiction of an environmental test system 100 that is constructed in accordance with the claimed embodiments.

The environmental test system 100 has a first enclosure 102 having three pairs of opposing wall members forming a closed structure that defines an internal cavity, referred to herein as a testing volume 103. That is, the first enclosure 102 has a left-side upstanding wall 104 and an opposing right-side upstanding wall 106, joined at proximal and distal ends, respectively, to a bottom wall 108 and an opposing top wall 110. A rear wall 111 (FIG. 6) and an opposing front wall 112 complete the enclosure 102.

In these illustrative embodiments the front wall 112 is a door that is operably supported by hinges 114 to gain access to the testing volume 103. A latch 116 operably secures the door in a closed position. A seal (not shown) is affixed to the door to thermally isolate the testing volume 103 from ambient conditions when the door is latched.

Although the illustrative embodiments depict the front wall 112 being a solid hinged door, the claimed embodiments are not so limited. In alternative equivalent embodiments the front wall 112 can be or can incorporate a transparent pane for viewing into the testing volume 103 when the door is latched. In other equivalent alternative embodiments the front wall 112 can be a sliding door, being either solid or having a viewing pane.

Inside the testing volume 103 is a fixture 118 that receivingly engages a plurality of the data storage devices 10 for functionally testing them. In the illustrative embodiments the fixture 118 has twelve rows with five test cells 120 in each row. FIG. 4 is an isometric depiction of one of the test cells 120 removed from its receptacle in the fixture 118. Each test cell 120 has two slidable trays 122 into each of which a data storage device 10 is placed for testing. Thus, the fixture 118 in the illustrative embodiments is capable of testing 120 data storage devices 10 simultaneously.

Returning to FIGS. 2 and 3, the environmental test system 100 has a controller 124 that is electronically connected to each of the test cells 122. The controller 124 executes programming instructions stored in memory to functionally test the data storage devices 10. In the depicted embodiments the controller 124 is inside the enclosure 102, but the claimed embodiments are not so limited. In alternative equivalent embodiments the controller 124 can be located outside the enclosure 102 with remote wiring that penetrates one of the walls, such as the conduit 126 depicted penetrating the top wall 110.

The illustrative environmental test system 100 also has a second enclosure 128 likewise having three pairs of opposing wall members forming a closed structure that defines an internal cavity, referred to herein as a control volume 130. That is, the second enclosure 128 has a left-side upstanding wall 132 and an opposing right-side upstanding wall 134, joined at proximal and distal ends, respectively, to a bottom wall 136 and an opposing top wall 140. A rear wall (not shown) and an opposing front wall 142 complete the enclosure 128. In these illustrative embodiments the front wall 142 includes a door 144 for gaining access to the control volume 130.

Note that the testing volume 103 and the control volume 130 are separately contained within the first enclosure 102 and the second enclosure 128, which do not share any common structural member. That is, the side wall 104 of the first enclosure 102 is spatially separated by a gap 146 from the adjacent side wall 134 of the second enclosure 128. Furthermore, the gap 146 is not spanned by any structural member of either enclosure 102, 128. This is because the purpose for the gap 146 is to mechanically isolate the testing volume 103 from the control volume 130. Accordingly, previously attempted solutions lacking individual enclosures that share no common structural members, such as 102, 128, and thereby define no gap therebetween, such as 146, are expressly not contemplated within the scope of the claimed embodiments.

Inside the control volume 130 is heating, venting, and air conditioning (HVAC) equipment, referred to herein as an air handler 148, that is capable of thermally conditioning air (or some other desired fluid) in the control volume 130 to a desired thermodynamic state. The air handler 148 includes an evaporative coil (or “evaporator”) 150 in which a compressed refrigerant removes heat from the air during expansion. Preferably, the compressed refrigerant is first subjected to a secondary cooling process before entering the evaporator 150, such as an exchange with an externally supplied chilled water and glycol or brine mixture, in a cascading refrigeration cycle capable of cooling the air in the control volume 130 to as low as −60 degrees Celsius.

The air handler 148 also has the capability of processing heated air with an electrical resistance strip heater 152. Preferably the heater 152 is sized to heat the air from the air handler 148 to as high as 90 degrees Celsius.

A blower 154 draws on the thermally conditioned air to positively pressurize ductwork connected to the air handler 148 and to the enclosure 102, to transfer the thermally conditioned air therebetween. Because the air handler 148 is disposed outside the testing volume 103, at least a portion of a supply duct 156 is disposed outside the enclosure 102 as well. A manifold inside the enclosure 102 is connected to the supply duct 156 for directing the thermally conditioned air over the plurality of data storage devices 10 in the test cells 118, in accordance with thermal state requirements associated with the functional testing. After flowing past respective rows of the test cells 118, the airflow is collected into a return duct 158 that transfers make up air back to the air handler 148.

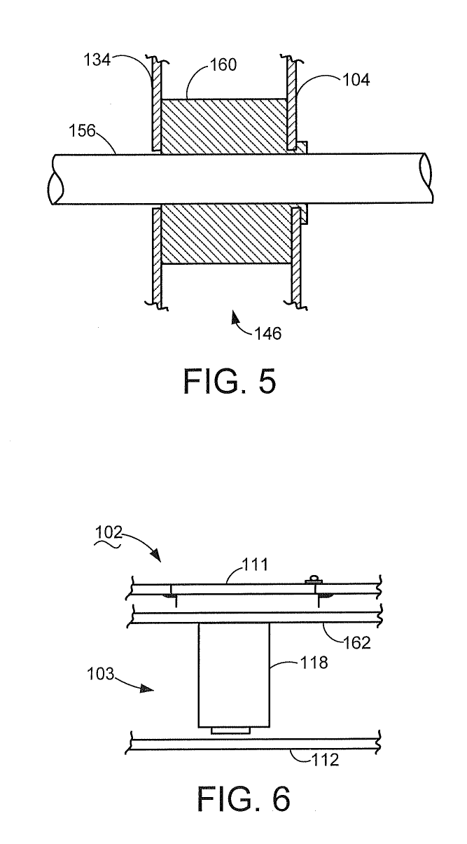

The supply duct 156 and the return duct 158 penetrate openings defined by the side wall 134 of the second enclosure 128, and openings defined by the side wall 104 of the first enclosure 102. FIG. 5 is an enlarged partial cross sectional view depicting the supply duct 156 where it penetrates the side walls 104, 134, spanning the gap 146 therebetween. An elastomeric damping member 160 mechanically isolates the supply duct 156 from the side walls 104, 134 at the penetrations. For additional support the damping member 160 can be sized so as to be compressingly sandwiched between the side walls 104, 134, as depicted in FIG. 5. Alternatively, a similar damping member could be cantilevered from either of the side walls 104, 134 and encompass the supply duct 156. The return duct 158 is likewise isolated for the side walls 104, 134 by another damping member.

FIG. 6 is a top view depiction of one of the test cells 118 in the testing volume 103 electronically connected to a backplane 162. The backplane 162 provides bus communications between the controller 124 and each of the test cells 118. Preferably, the rear wall 111 has one or more operable doors that, when open, afford access to the backplane 162 for selectively inserting and removing controls electronics. Like the door forming the front wall 112, the door in the rear wall 111 is closed against a seal to isolate the testing volume 103 in the sealed enclosure 102 from ambient air.

Thus, the testing volume 103 is isolated from mechanical excitations created by the working components of the HVAC equipment 148 because they are contained in separate enclosures 102, 128 that share no common structural member. The ductwork connected to the HVAC equipment 148 is isolated from the enclosure 102 by the damping member 160, which attenuates any vibrations transmitted via the ductwork. The enclosures 102, 128 are also each supported upon a plurality of vibration damping floor supports 164 to attenuate any vibrations transmitted into and from the floor. In this manner the mechanical excitations associated with operating an environmentally controlled testing chamber are effectively isolated from the testing volume 103.

It is to be understood that even though numerous characteristics and advantages of various embodiments have been set forth in the foregoing description, together with details of the structure and function of various embodiments, this description is illustrative only, and changes may be made in detail, especially in matters of structure and arrangements of parts within the principles of the present embodiments to the full extent indicated by the broad general meaning of the terms in which the appended claims are expressed. For example, the particular elements may vary in type or arrangement without departing from the spirit and scope of the present embodiments.

In addition, although the embodiments described herein are described in relation to functionally testing a data storage device, it will be appreciated by those skilled in the art that the claimed subject matter is not so limited and various other testing systems employing an environmentally controlled test chamber can utilize the present embodiments without departing from the spirit and scope of the claimed embodiments.

What is claimed is:

1. An environmental test system, comprising:
an enclosure containing a test fixture that receivingly engages a plurality of data storage devices during functional testing;
heating, venting, and air conditioning (HVAC) equipment capable of thermally conditioning an atmospheric fluid to a desired state; and
ductwork connected to the HVAC equipment and to the enclosure to transfer the thermally conditioned atmospheric fluid therebetween, wherein at least a portion of the ductwork is disposed outside the enclosure.

2. The system of claim 1 wherein the enclosure comprises three pairs of opposing wall members that form a closed structure defining an internal cavity, wherein the ductwork penetrates one of the wall members.

3. The system of claim 2 wherein one pair of the opposing walls comprises a door operable between an open position and a closed position, wherein the open position affords access to the test fixture for inserting and removing data storage devices under test, and wherein the closed position seals the enclosure.

4. The system of claim 3 wherein the wall opposite the door defines accessible openings operable between an open position and a closed position, wherein the open position affords access to a backplane portion of the test fixture for selectively inserting and removing controls electronics, and wherein the closed position seals the enclosure.

5. The system of claim 2 wherein the ductwork comprises a damping member that mechanically isolates the ductwork from the wall member at the penetration.

6. The system of claim 5 wherein the damping member comprises an elastomeric material.

7. The system of claim 5 wherein the ductwork comprises a supply duct that transfers the thermally conditioned atmospheric fluid to the enclosure and a separate return duct that transfers make up atmospheric fluid to the HVAC equipment.

8. The system of claim 7 comprising a manifold at least partially disposed in the enclosure and connected to the supply duct to distribute the thermally conditioned atmospheric fluid substantially evenly to the test fixture.

9. The system of claim 2 comprising a controller that is electronically connected to the test fixture and that executes programming instructions stored in memory to functionally test the data storage devices.

10. The system of claim 9 wherein the HVAC equipment is contained within a second enclosure that is separate from the other enclosure that houses the data storage devices during functional testing.

11. The system of claim 10 wherein the controller is located in the second enclosure.

12. The system of claim 11 wherein the second enclosure comprises three pairs of opposing walls forming a closed structure defining an internal cavity, wherein the walls of the second enclosure noncontactingly engage the walls of the other enclosure that houses the data storage devices during functional testing.

13. The system of claim 12 wherein the HVAC equipment comprises an evaporative cooler that is capable of thermally conditioning the atmospheric fluid to about −40 degrees Celsius.

14. The system of claim 13 wherein the HVAC equipment comprises an electrical resistance heater that is capable of thermally conditioning the environmental fluid to about 90 degrees Celsius.

15. A data storage device environmental test system comprising a testing volume and a control volume that are separately contained in first and second enclosures, respectively, the first and second enclosures possessing no common structural member.

16. The system of claim 15 wherein the first enclosure defines a cavity containing a test fixture that receivingly engages a plurality of the data storage devices during functional testing, wherein the second enclosure defines a cavity containing HVAC equipment capable of thermally conditioning an atmospheric fluid to a desired state, and the system further comprising ductwork connected to the HVAC equipment and to the enclosures to transfer the thermally conditioned atmospheric fluid therebetween, wherein at least a portion of the ductwork is disposed outside the enclosures.

17. The system of claim 16 wherein the first enclosure comprises three pairs of opposing wall members that form a closed structure defining an internal cavity, wherein the ductwork penetrates one of the wall members.

18. The system of claim 17 comprising a damping member that mechanically isolates the ductwork from the wall member at the penetration.

19. The system of claim 18 wherein the damping member comprises an elastomeric material.

20. A method comprising:
thermally conditioning an atmospheric fluid to a desired state in a first enclosure;
transferring the thermally conditioned atmospheric fluid to a second sealed enclosure separate from the first enclosure, the second enclosure housing a plurality of data storage devices during functional testing, and the desired state associated with subjecting the data storage devices to a desired environmental condition as a constituent of the functional testing; and
transferring makeup atmospheric fluid from the second enclosure to the first enclosure.
